(19) United States
(12) Patent Application Publication
(10) Pub. No.: US 2019/0053522 A1
(43) Pub. Date: Feb. 21, 2019

(54) Apparatus, System, and Method for Quinoa Food Products

(71) Applicant: IMA USA, L.L.C., Washington, UT (US)

(72) Inventor: Augusto C. Carbonari, Jaguariuna (BR)

(21) Appl. No.: 15/678,779

(22) Filed: Aug. 16, 2017

(51) Int. Cl. A23L 7/10; A23L 5/20; A23P 30/20; A23P 10/40; F26B 5/06

(52) U.S. Cl. CPC A23L 7/198; A23L 5/21; F26B 5/065; A23P 10/40; A23P 30/20

(57) ABSTRACT

A method for producing powdered quinoa. The method includes dehulling quinoa in a dehuller in some embodiments. The quinoa is dried in a dryer in some embodiments. The quinoa is soaked in a soaker and freeze dried in a freeze dryer. In certain embodiments, the quinoa is extruded on an extruder. In one embodiment, the quinoa is ground in a grinder.

### CROSS-REFERENCE TO RELATED APPLICATIONS

N/A

### SUMMARY

Embodiments of a method for producing powdered quinoa are described. The method includes dehulling quinoa in a dehuller in some embodiments. The quinoa is dried in a dryer in some embodiments. The quinoa is soaked in a soaker and freeze dried in a freeze dryer. In certain embodiments, the quinoa is extruded on an extruder. In one embodiment, the quinoa is ground in a grinder. Other embodiments are also described.

### BRIEF DESCRIPTION OF THE SEVERAL VIEWS OF THE DRAWINGS

FIG. 1 is a block diagram depicting one embodiment of a quinoa processing system.

FIG. 2 is a block diagram depicting an embodiment of the grain conditioner of FIG. 1.

FIG. 3 is a block diagram depicting an embodiment of the quinoa processor of FIG. 1.

FIG. 4 is a block diagram depicting an embodiment of the liquid product processor of FIG. 1.

FIG. 5 is a block diagram depicting an embodiment of the noodle processor of FIG. 1.

FIG. 6 depicts a flowchart diagram showing an embodiment of a method for conditioning grain.

FIG. 7 depicts a flowchart diagram showing an embodiment of a method for processing quinoa.

FIG. 8 depicts a flowchart diagram showing an embodiment of a method for processing liquid products.

FIG. 9 depicts a flowchart diagram showing an embodiment of a method for processing juice drinks.

FIG. 10 depicts a flowchart diagram showing an embodiment of a method for producing noodles.

FIG. 11 depicts a flowchart diagram showing an embodiment of a method for producing cereal products.

FIG. 12 depicts a flowchart diagram showing an embodiment of a method for producing snack products.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments illustrate methods of production of quinoa food products.

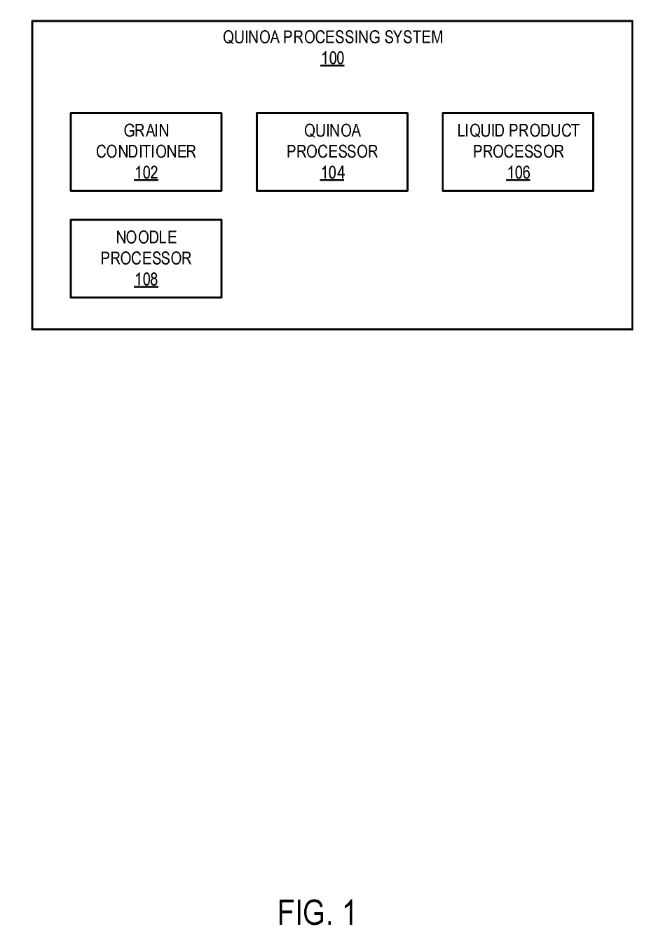

FIG. 1 is a block diagram depicting one embodiment of a quinoa processing system 100. The quinoa processing system 100 includes a grain conditioner 102, a quinoa processor 104, a liquid product processor 106, and a noodle processor 108. The quinoa processing system 100 transforms threshed quinoa into various food products. Each of the grain conditioner 102, the quinoa processor 104, the liquid product processor 106, and the noodle processor 108 are described in greater detail below.

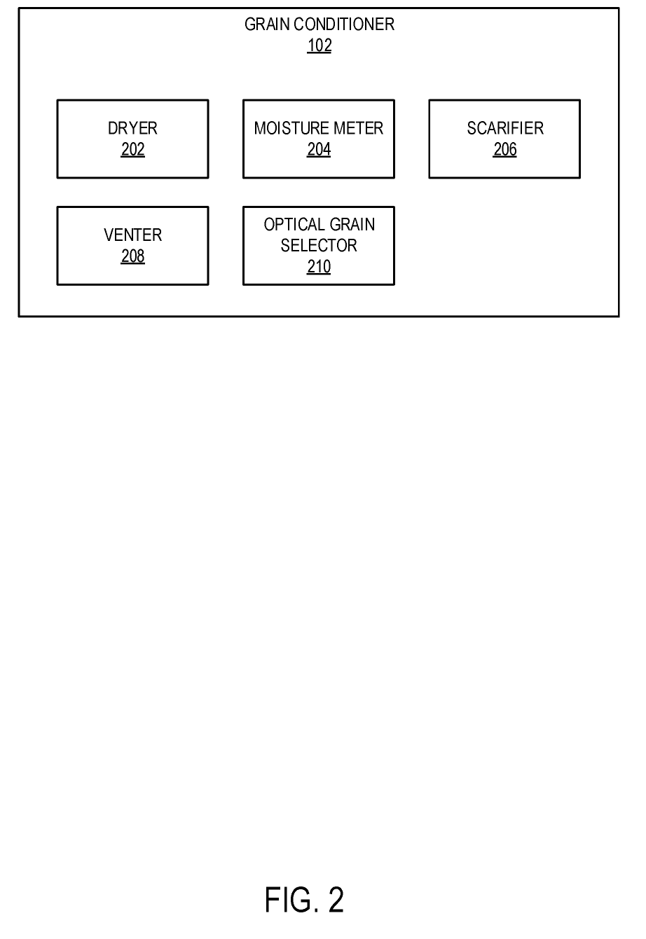

FIG. 2 is a block diagram depicting an embodiment of the grain conditioner 102 of FIG. 1. The grain conditioner 102 includes a dryer 202, a moisture meter 204, a scarifier 206, a venter 208, and an optical grain selector 210. The grain conditioner 102 prepares threshed quinoa for use in subsequent processes.

The dryer 202 removes moisture from threshed quinoa. The dryer 202, in some embodiments, uses forced air to remove moisture from the quinoa. In one embodiment, the dryer 202 includes a heater (not shown) to add heat to the quinoa to accelerate the drying process.

In some embodiments, a moisture meter 204 measures moisture. The moisture meter 204 may be a hygrometer configured to measure the moisture in the air around the quinoa. In an alternate embodiment, the moisture meter 204 may measure moisture content in the quinoa. The dryer 202 may be controlled in response to a signal from the moisture meter 204. For example, the dryer 202 may cease operation in response to a determination from the moisture meter 204 that the measured moisture is below a predetermined level.

The scarifier 206, in one embodiment, scarifies the quinoa. The scarifier 206 may operate to weaken, open, or otherwise alter the coat of the quinoa. The scarifier 206 may operate using any known mode of scarification. For example, the scarifier 206 may be a mechanical scarifier, a chemical scarifier, or a thermal scarifier. The venter 208, in some embodiments, vents the quinoa. The venter 208 may operate using any known mode of venting.

In some embodiments, the optical grain selector 210 uses predetermined criteria to select and/or reject quinoa grains. The optical grain selector 210 may operate based on color, shape, size, or other criteria of the quinoa. The optical grain selector 210 may operate to reject quinoa and direct the system 100 to dispose of rejected quinoa.

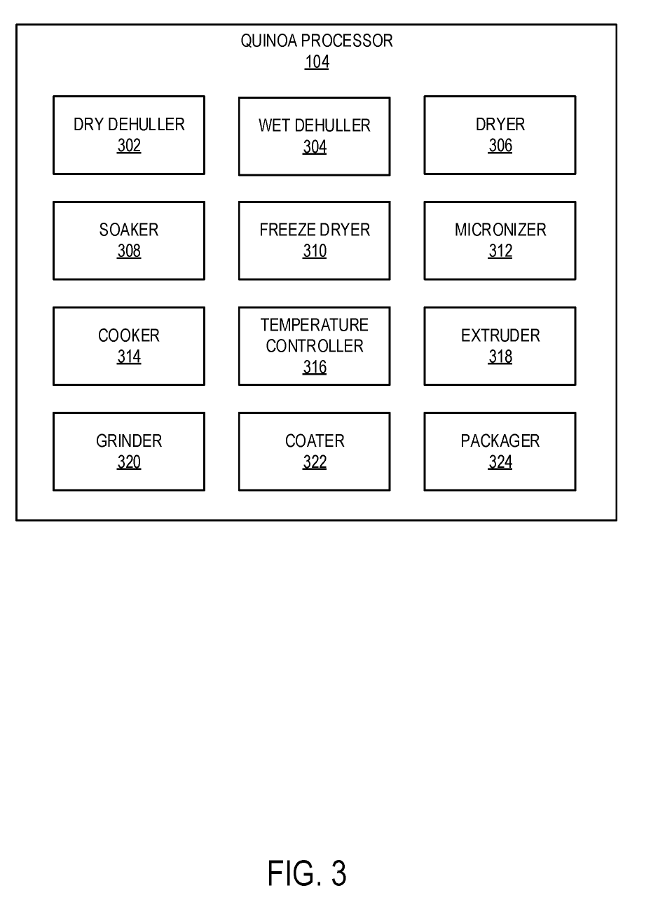

FIG. 3 is a block diagram depicting an embodiment of the quinoa processor 104 of FIG. 1. The quinoa processor 104 includes a dry dehuller 302, a wet dehuller 304, a dryer 306, a soaker 308, a freeze dryer 310, a micronizer 312, a cooker 314, a temperature controller 316, an extruder 318, a grinder 320, a coater 322, and a packager 324. The quinoa processor 104 receives conditioned quinoa and outputs refined quinoa and/or quinoa food products.

The dry dehuller 302, in some embodiments, removes at least a portion of the hull of the quinoa. Removal of hull may improve the taste and other characteristics of the quinoa, for example, by removing saponins found in the hull. The dry dehuller 302 may use mechanical abrasion to separate hull from the quinoa. Any known type of dry hulling machine may operate as the dry dehuller 302.

In some embodiments, a wet dehuller 304 is configured to remove at least a portion of the hull of the quinoa. The wet dehuller 304 may incorporate water in the dehulling process. The wet dehuller 304 may operate to remove additional hull not removed by the dry dehuller 302.

The quinoa processor 104 may include a dryer 306 configured to dry quinoa after one or more operations. For example, the dryer 306 may be used to dry quinoa after operation of the wet dehuller 304. The dryer 306 may use any type of drying method, including, but not limited to, forced air, heat, and the like.

In some embodiments, the soaker 308 operates to soak the quinoa in a liquid, such as water. Use of the soaker 308 may operate to remove undesirable compounds associated with quinoa, such as phytates and oxalates. In some embodiments, the soaker 308 provides an environment favorable to pre-germination or germination processes of the quinoa. The soaker 308 may operate for any pre-determined amount of time. For example, the soaker 308 may be configured to operate for twenty four hours. In another example, the soaker 308 may be configured to operate for over eight hours. In yet another example, the soaker 308 may be configured to operate for between twenty two and twenty six hours. In another example, the soaker 308 may be configured to operate for a period of time sufficient to initiate germination of the quinoa.

The freeze dryer 310, in some embodiments, freeze dries quinoa. The freeze dryer 310 may create an environment with low pressure and temperature that causes at least some moisture in the quinoa to sublimate. Freeze drying in the freeze dryer 310 may preserve various desirable characteristics of the quinoa.

The micronizer 312, in one embodiment, is configured to control particle sizes of grains in the quinoa processor 104. In some embodiments, the quinoa processor 104 includes more than one micronizer 312 operating at different stages in the process or using different criteria for particle size selection. As used herein, the micronizer 312 may refer to a single micrionizer or to more than one micronizer. The micronizer 312 may operate on the quinoa before it enters the extruder 318 to control particle sizes entering the extruder 318 to manage reactions inside the extruder 318. In some embodiments, the micronizer 312 operates after extrusion in the extruder 318 to improve consistency and reaction of an output product.

Experimentation by the inventors has shown that a mouth pleasant output product with acceptable solubility and stability can be obtained by configuration of the micronizer 312 using a #200 sieve and a #325 sieve operated such that approximately 12.09% is retained on the #200 sieve and 10.36% is retained on the #325 sieve. In one example, the micronizer 312 is configured to retain between 11% and 13% on sieve #200 and between 9% and 11% on sieve #325.

The cooker 314, in some embodiments, is configured to apply heat to the quinoa. The cooker 314 may be a discrete component, or it may be integrated with another component of the quinoa processor 104. For example, the cooker 314 may be integrated with the extruder 318.

The cooker 314 may be configured to apply a predetermined level of heat to the quinoa. In some embodiments, the cooker 314 is influenced by the temperature controller 316. The temperature controller 316 adjusts a temperature of the cooker 314 to a predetermined level. In some embodiments, the temperature controller 316 controls multiple zones of the cooker 314 at individually predetermined temperatures. For example, the temperature controller 316 may cause the cooker 314 to operate at three different temperatures in three different zones. In one example, the cooker 314 may be controlled by the temperature controller 316 to operate at 80° C. in a first zone, at 100° C. in a second zone, and at 140° C. in a third zone. In another example, the cooker 314 may be controlled by the temperature controller 316 to operate at within 5° C. of 80° C. in a first zone, at within 5° C. of 100° C. in a second zone, and at within 5° C. of 140° C. in a third zone. Cooking the quinoa at different temperatures in different zones has been shown through experimentation by the inventors to yield unexpectedly different qualities in output products.

The extruder 318, in one embodiment, extrudes the quinoa. The extruder 318 may be any type of extruder. In some embodiments, the extruder 318 uses a screw to move quinoa through the extruder 318. In one embodiment, the extruder 318 is a dual screw extruder. Experimentation by the inventors has shown that unexpectedly different qualities are obtained by using a dual screw extruder relative to use of a single screw extruder.

In certain embodiments, the extruder 318 may be configured to have two 4 mm apertures. The extruder 318 may be configured to rotate at a predetermined rate. For example, the screws in the extruder 318 may rotate at a speed between 1300 RPM and 1500 RPM. In one example, the screws in the extruder 318 rotate at approximately 1400 RPM.

In some embodiments, the grinder 320 grinds the quinoa to reduce particles of quinoa to a predetermined size. The grinder 320 may be any type of grinder known in the art, such as a mill. In some embodiments, the output of the grinder 320 is micronized by the micronizer 312 to achieve a predetermined particle size.

The coater 322, in some embodiments, is configured to coat quinoa output by the quinoa processor 104. For example, the quinoa processor 104 may be configured to output a cereal product, and the coater 322 may coat the cereal product with a sweetener. In another example, the quinoa processor 104 may be configured to output a snack product, and the coater 322 may coat the snack product with a flavoring.

In some embodiments, the packager 324 packages quinoa products output by the quinoa processor 104. For example, the output product may be a quinoa powder, and the packager 324 may package the output product in containers for shipping or later use.

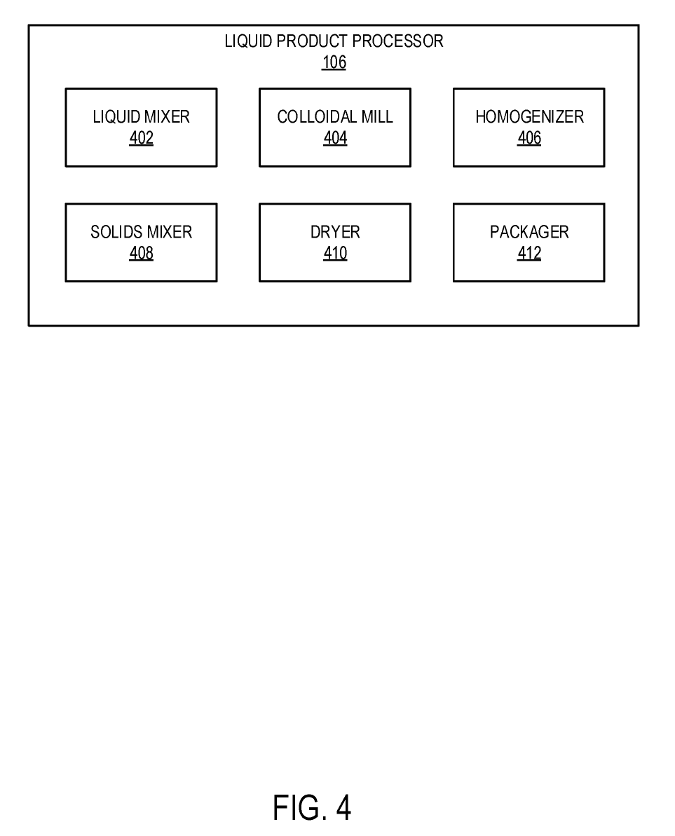

FIG. 4 is a block diagram depicting an embodiment of the liquid product processor 106 of FIG. 1. The liquid product processor 106 includes a liquid mixer 402, a colloidal mill 404, a homogenizer 406, a solids mixer 408, a dryer 410, and a packager 412. The liquid product processor 106 processes powdered quinoa into various liquid or semi-liquid products.

The liquid mixer 402, in one embodiment, mixes a liquid with powdered quinoa output by the quinoa processor 104. The liquid may be any type of liquid. For example, the liquid mixed with powdered quinoa may be water, fruit juice, syrup, or the like. The liquid mixer 402 may operate to mix a powder/liquid composite for a predetermined time or rate or may operate in response to a measured characteristic of the composite.

The colloidal mill 404, in some embodiments, operates to reduce the particle size of the quinoa powder suspended in the liquid. The colloidal mill 404 may operate on the powder/liquid composite for a predetermined time or rate or may operate in response to a measured characteristic of the composite.

In some embodiments, the homogenizer 406 operates to reduce the particle size of the quinoa powder suspended in the liquid. The homogenizer 406 may be any known type of homogenizer. For example, the homogenizer 406 may be a high pressure homogenizer that forces the powder/liquid composite through a relatively small opening under high pressures. The powder/liquid composite output by the colloidal mill 404 or the homogenizer 406 may result in a relatively uniform mixture that remains relatively stable over time after processing.

The solids mixer 408, in one embodiment, mixes an additional non-liquid into the quinoa powder and liquid mixture. The solids mixer 408 may mix the additional non-liquid into the quinoa powder prior to mixing with liquid in the liquid mixer 402. In another embodiment, the solids mixer 408 mixes an additional non-liquid into the powder/liquid composite formed by the liquid mixer 402. In some embodiments, the solids mixer 408 mixes a sweetener, such as sugar or sugar alcohol, with one or more other components. In some embodiments, the solids mixer 408 mixes a flavoring, such as vanilla, sea salt, or cocoa powder, with one or more other components.

In some embodiments, the dryer 410 removes moisture from a liquid produced by the liquid product processor 106. The dryer 410 may use any method of removing moisture from the liquid, including evaporation, heating, or the like. The dryer 410 may operate until the liquid is concentrated to a predetermined consistency. For example, the dryer 410 may operate on the liquid until it is concentrated to the consistency of cream, of custard, or of paste.

In some embodiments, the packager 412 packages quinoa products output by the liquid product processor 106. For example, the output product may be a quinoa milk, and the packager 412 may package the output product in containers for shipping or later use. The packager 412 may also package other output products, such as sweetened quinoa milk, quinoa chocolate milk, quinoa cream, quinoa chocolate cold dessert, quinoa paste, quinoa chocolate paste, or quinoa fruit juice.

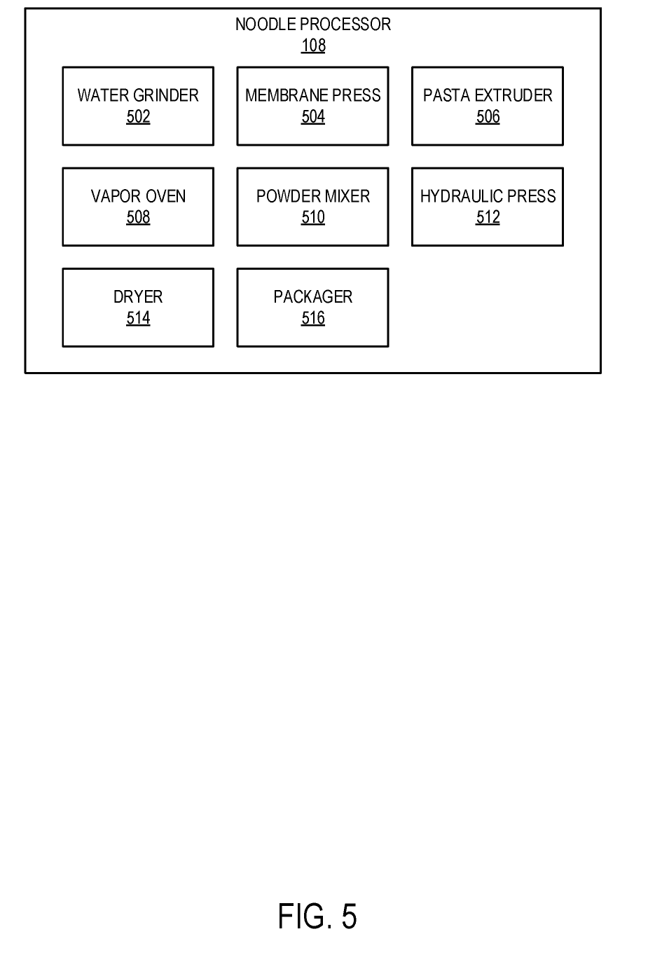

FIG. 5 is a block diagram depicting an embodiment of the noodle processor 108 of FIG. 1. The noodle processor 108 includes a water grinder 502, a membrane press 504, a pasta extruder 506, a vapor oven 508, a powder mixer 510, a hydraulic press 512, a dryer 514, and a packager 516. The noodle processor 108 produces noodle products that include quinoa.

The water grinder 502, in one embodiment, is configured to grind rice with water. Embodiments of the membrane press 504 are configured to filter ground rice. The pasta extruder 506, in one embodiment, is configured to extrude and homogenize ground rice. In some embodiments, the vapor oven 508 is configured to cook extruded rice. The water grinder 502, the membrane press 504, the pasta extruder 506, and the vapor oven 508 may be any type of such products known in the art.

The powder mixer 510, in certain embodiments, is configured to add quinoa powder produced by the quinoa processor 104 to extruded rice noodles. The powder mixer 510 may add quinoa powder at a predetermined rate to the extruded rice noodles.

In some embodiments, the mixed rice noodles and quinoa are extruded through a pasta extruder 506. The pasta extruder 506 is configured to homogenize the mixed rice noodles and quinoa.

The hydraulic press 512, in one embodiment, is configured to extrude the mixed rice noodles and quinoa into noodles. The dryer 514, in some embodiments, is configured to dry the extruded rice and quinoa noodles. The dryer 514 may be any type of dryer known in the art, such as a forced hot air chamber. The noodles my dry for a predetermined time, such as ten to twelve hours.

In some embodiments, the packager 516 packages noodles output by the noodle processor 108. In some embodiments, the packager 516 adds one or more additional components, such as a flavoring sachet.

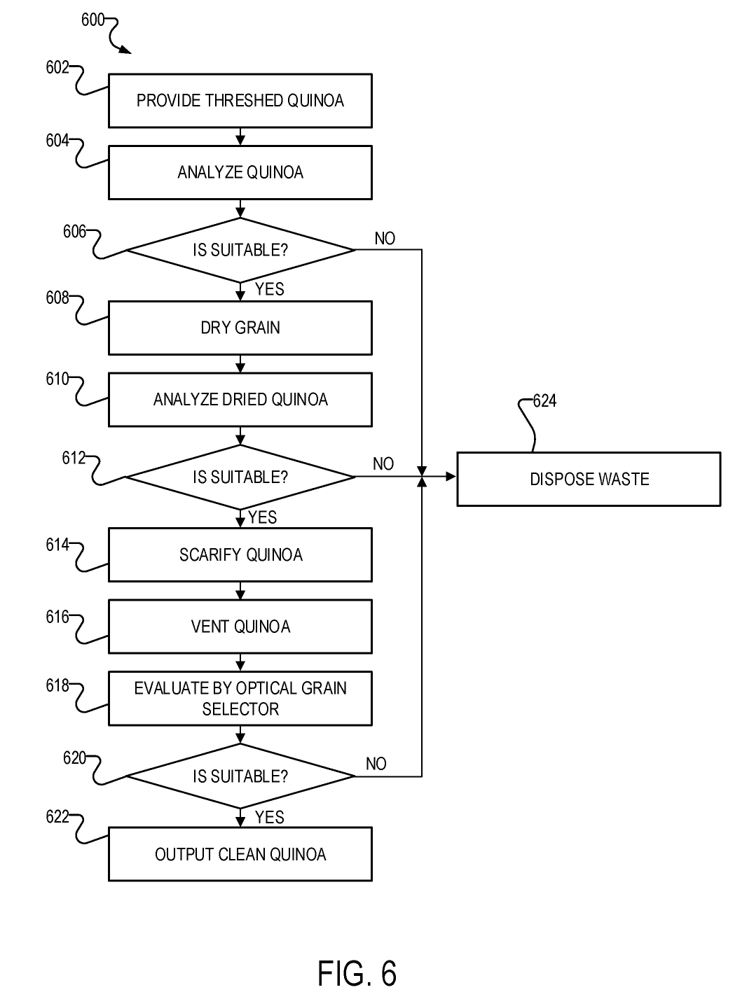

FIGS. 6-12 depict flowchart diagrams showing embodiments of methods for producing quinoa food products. The methods are in certain embodiments methods of use of the system and apparatus of FIGS. 1-5, and will be discussed with reference to those figures. Nevertheless, the methods may also be conducted independently thereof and are not intended to be limited specifically to the specific embodiments discussed above with respect to those figures.

FIG. 6 illustrates an embodiment of a method 600 for conditioning grain. As shown in FIG. 6, threshed quinoa is provided 602. The threshed quinoa is analyzed 604 to determine 606 if the threshed quinoa is suitable for use in additional processes. If the quinoa is determined 606 to be suitable, it is dried 608 in a dryer 202.

Dried quinoa is analyzed 610 to determine 612 if the dried quinoa is suitable for use in additional processes. In some embodiments, the analysis 610 includes a measurement of moisture by a moisture meter 204 to determine a moisture level of the quinoa or the atmosphere around the quinoa. In some embodiments, if the quinoa is determined 612 to be suitable, it is scarified 614 in a scarifier 206. The quinoa may be vented 616 in a venter 208. In certain embodiments, an optical grain selector 210 evaluates 618 the quinoa. If the optical grain selector 210 determines 620 that the quinoa meets predetermined criteria, the grain conditioner 102 outputs clean quinoa. If any determination 606, 612, or 620 determines that the quinoa is unsuitable, the quinoa is disposed 624.

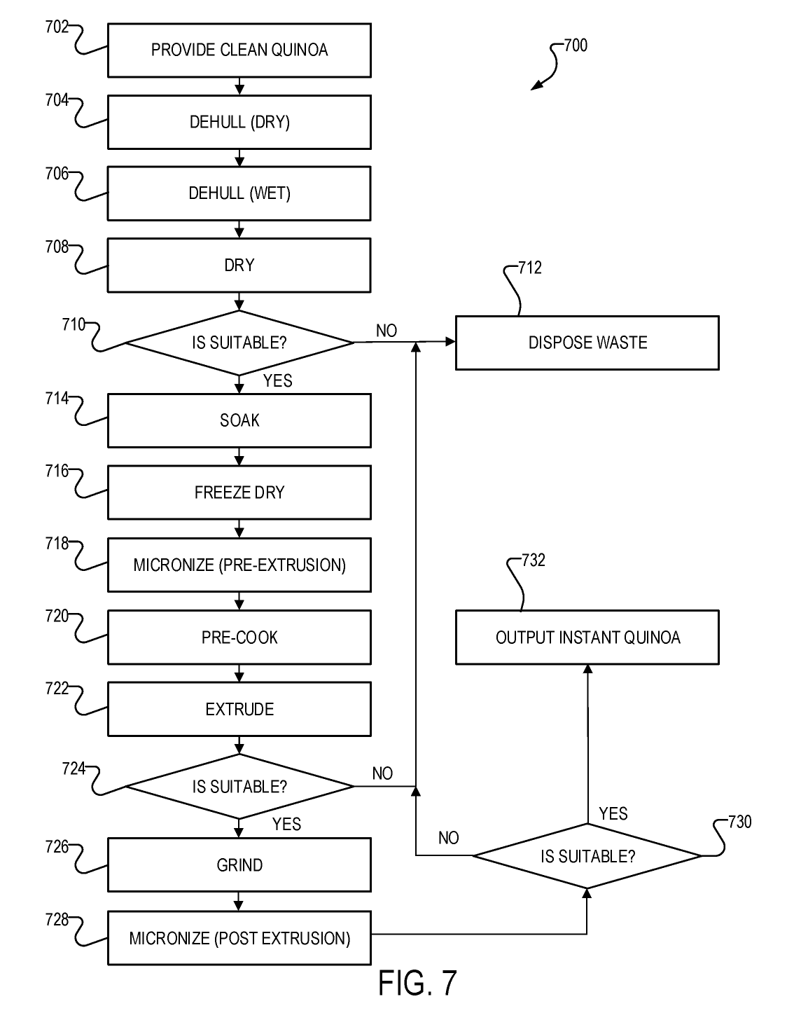

FIG. 7 illustrates an embodiment of a method 700 for processing quinoa. As shown in FIG. 7, clean quinoa is provided 702. The quinoa is dehulled 704 in a dry dehuller 302. In some embodiments, the quinoa is dehulled 706 in a wet dehuller 304. Dehulled quinoa may be dried 708 in a dryer 306.

Dried quinoa is analyzed to determine 710 if it is suitable for use in additional processes. If the quinoa is suitable, it is soaked 714 in a soaker 308. The quinoa may be soaked 714 for a predetermined length of time. It may, for example, be soaked 714 for approximately twenty four hours.

In certain embodiments, the quinoa is freeze dried 716 in a freeze dryer 310. The quinoa may be micronized 718 in a micronizer 312 that outputs quinoa particles of a predetermined particle size. In one embodiment, the quinoa is pre-cooked 720 in a cooker 314. The cooker 314 may be controlled by a temperature controller 316. The cooker 314 may cook 720 the quinoa in more than one zone having a different temperature in each zone, the temperature controlled by the temperature controller 316.

The quinoa may be extruded 722 in an extruder 318. The cooker 314 may be integrated with the extruder 318. Extruded quinoa may be analyzed to determine 724 if it is suitable for use in additional processes. If the quinoa is suitable, it is ground 726 in a grinder 320. If the ground quinoa is determined 730 to be suitable, it is output as powdered quinoa or instant quinoa. If any determination 710, 724, or 730 determines that the quinoa is unsuitable, the quinoa is disposed 732.

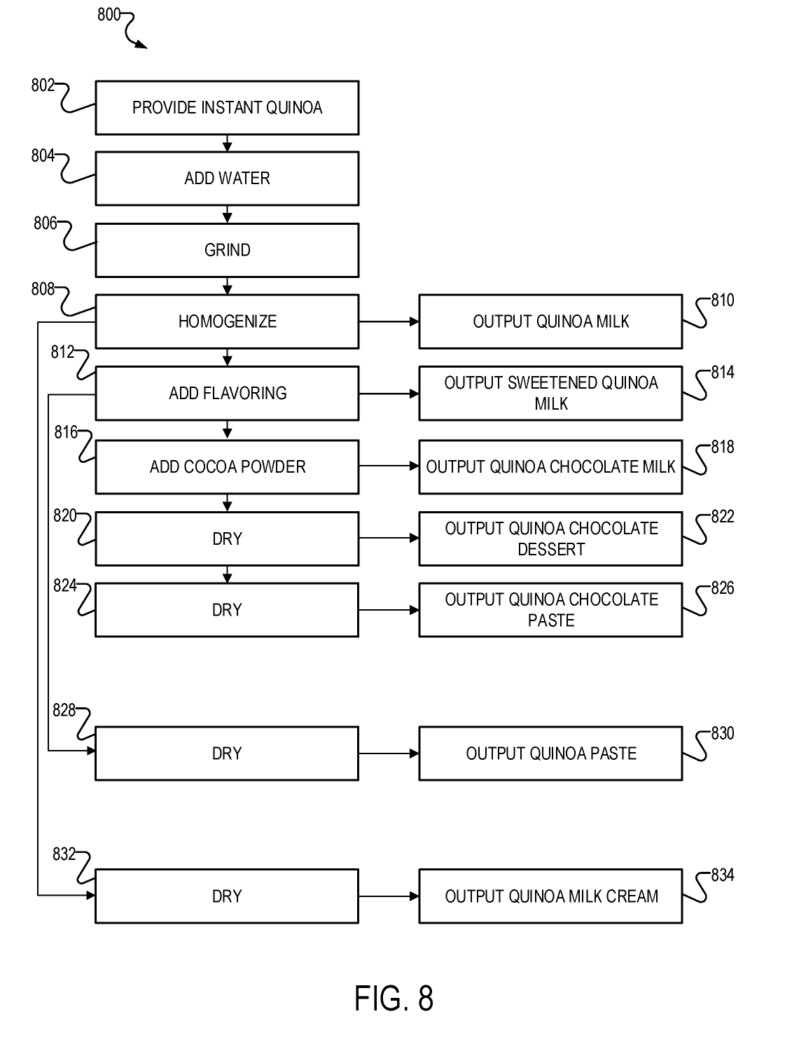

FIG. 8 illustrates an embodiment of a method 800 for processing liquid products. As shown in FIG. 8, instant quinoa 802 is provided 802. Water is added 804 to the instant quinoa in a liquid mixer 402. The mixture may be ground 806 in a mill such as a colloidal mill 404, or homogenized 808 in another type of homogenizer 406, such as a high pressure homogenizer. Quinoa milk may be output 810 from the ground 806 or homogenized 808 quinoa/water mixture.

In some embodiments, flavoring, such as sweetener, vanilla, and salt, may be added 812 by a solids mixer 408 to the quinoa milk. Sweetened quinoa milk may be output 814 from the flavoring 812 process.

Cocoa powder may be added 816 by a solids mixer 408 to the sweetened quinoa milk in some embodiments. Quinoa chocolate milk may be output 818 from the cocoa mixing 812 process. In some embodiments, the quinoa chocolate milk is dried 820 in a dryer 410 until it reaches a custard consistency. Quinoa chocolate dessert may be output 822 from the drying 820 process. In another embodiment, quinoa chocolate milk is dried 824 in a dryer 410 until it reaches a paste consistency. Quinoa chocolate paste may be output 826 from the drying 824 process.

Sweetened quinoa milk may be dried 828 in a dryer 410 until it reaches a paste consistency. Quinoa paste may be output 830 from the drying 828 process. Quinoa milk may be dried 832 in a dryer 410 until it reaches a creamy consistency. Quinoa cream may be output 834 from the drying 832 process.

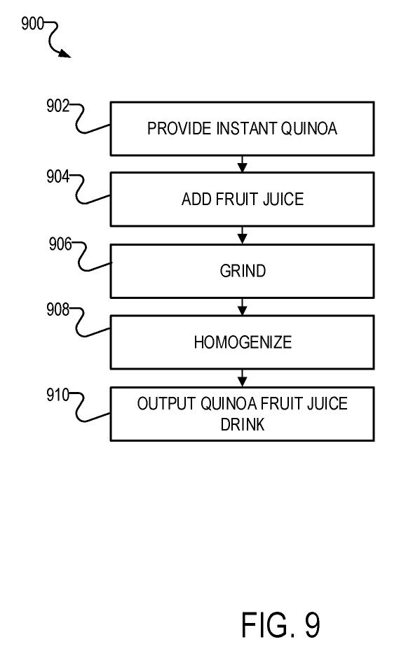

FIG. 9 illustrates an embodiment of a method 900 for processing juice drinks. As shown in FIG. 9, instant quinoa is provided 902. Fruit juice is added 904 to the instant quinoa in a liquid mixer 402. The mixture may be ground 906 in a mill such as a colloidal mill 404, or homogenized 908 in another type of homogenizer 406, such as a high pressure homogenizer. Quinoa fruit juice drink may be output 910 from the ground 906 or homogenized 908 quinoa/water mixture.

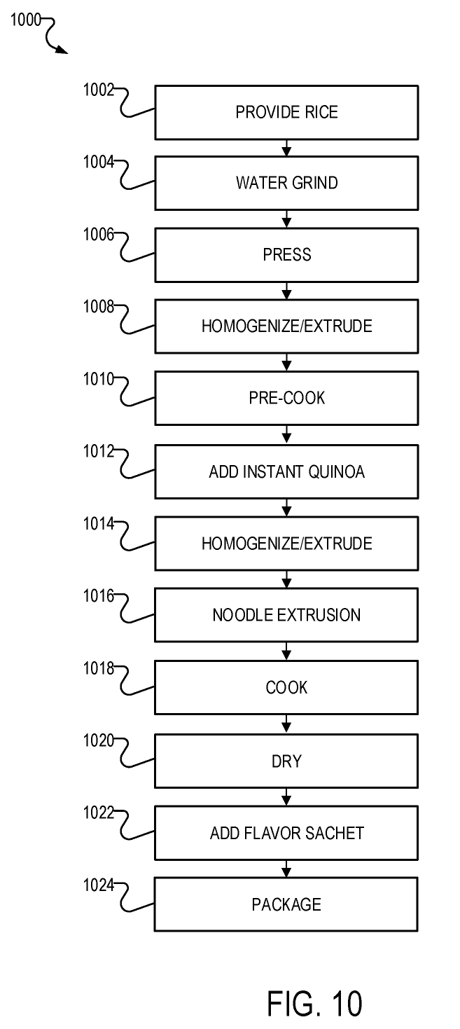

FIG. 10 illustrates an embodiment of a method 1000 for producing noodles. As shown in FIG. 10, rice is provided 1002. The rice is water ground 1004 on a water mill 502, pressed 1006 in a membrane press 504, extruded 1008 in a pasta extruder 506 and pre-cooked 1010 in a vapor oven 508.

In some embodiments, instant quinoa is added 1012 to the pre-cooked rice pasta using a powder mixer 510. The mixed rice pasta and instant quinoa may be homogenized and extruded 1014 through the pasta extruder 506. In some embodiments, the mixture is extruded 1016 through a hydraulic press 512 to form noodles. The noodles may be cooked 1018 in the vapor oven 508.

Cooked noodles, in certain embodiments, are dried 1020 in a dryer to a predetermined moisture level. A packager 516 may add 1022 a flavor sachet and package 1024 the noodles.

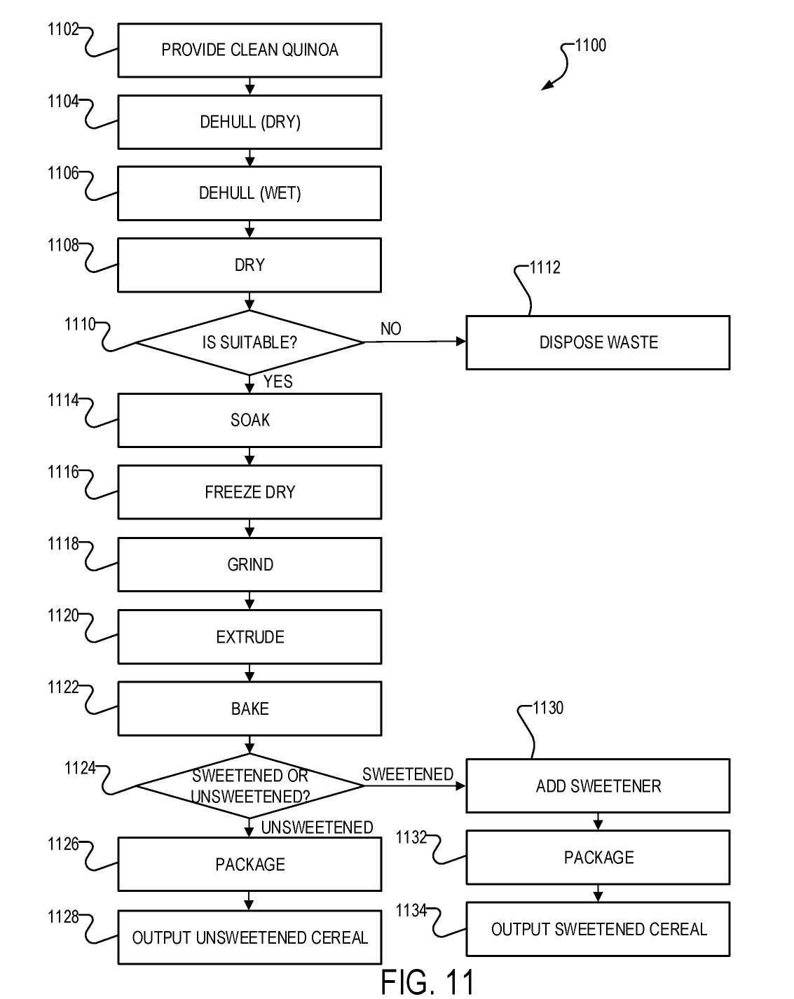

FIG. 11 illustrates an embodiment of a method 1100 for producing cereal products. As shown in FIG. 11, clean quinoa is provided 1102. The quinoa is dehulled 1104 in a dry dehuller 302. In some embodiments, the quinoa is dehulled 1106 in a wet dehuller 304. Dehulled quinoa is dried 1108 in a dryer 306.

Dried quinoa is analyzed to determine 1110 if it is suitable for use in additional processes. If the dried quinoa is determined 1110 to be unsuitable, the quinoa is disposed 1112.

If the quinoa is suitable, it is soaked 1114 in a soaker 308. The quinoa may be soaked 1114 for a predetermined length of time. It may, for example, be soaked 1114 for approximately twenty four hours.

In certain embodiments, the quinoa is freeze dried 1116 in the freeze dryer 310. The quinoa may be ground 1118 in a grinder 320 that outputs quinoa particles of a predetermined particle size. In one embodiment, the quinoa is extruded 1120 in an extruder 318.

The extruded quinoa may be baked 1122 in a cooker 314. The cooker 314 may be controlled by a temperature controller 316. The cooker 314 may bake 1122 the quinoa in more than one zone having a different temperature in each zone controlled by the temperature controller 316. The cooker 314 may be integrated with the extruder 318.

In some embodiments, the system 100 determines 1124 if the baked quinoa is to be sweetened or unsweetened. If the baked quinoa is to be unsweetened, it is packaged 1126 in a packager 324 and output 1128 as unsweetened cereal.

If the baked quinoa is to be sweetened, sweetener is added 1130 in a coater 322. The sweetened quinoa is packaged 1132 in the packager 324 and is output 1134 as sweetened cereal.

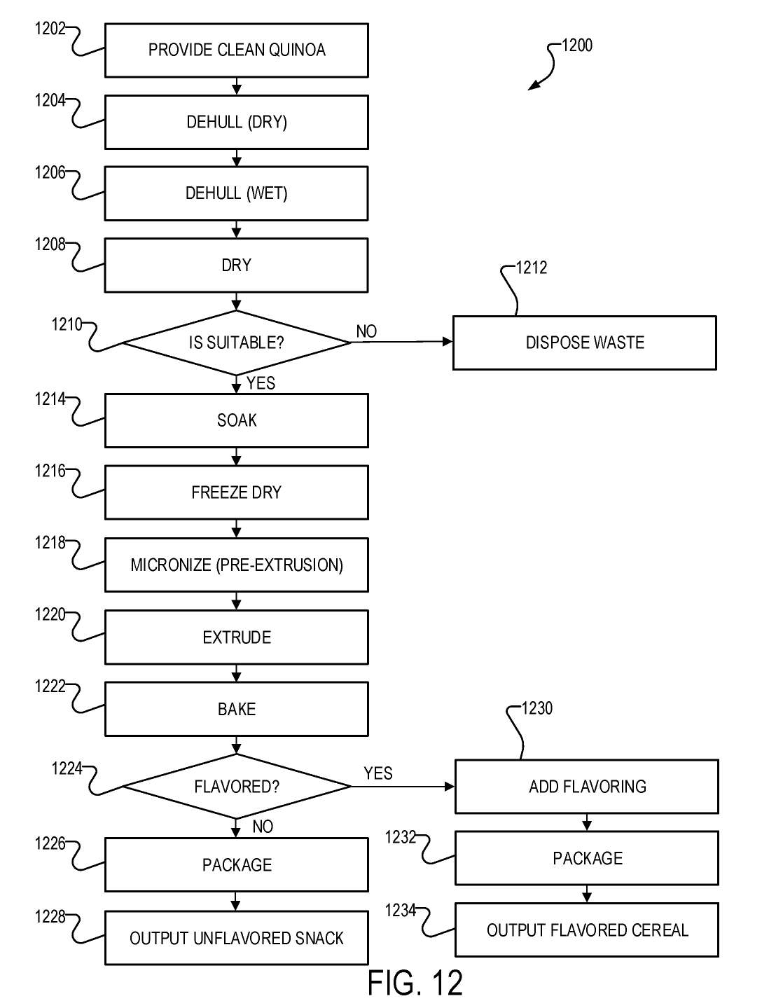

FIG. 12 illustrates an embodiment of a method 1200 for producing snack products. As shown in FIG. 12, clean quinoa is provided 1202. The quinoa is dehulled 1204 in a dry dehuller 302. In some embodiments, the quinoa is dehulled 1206 in a wet dehuller 304. Dehulled quinoa is dried 1208 in a dryer 306.

Dried quinoa is analyzed to determine 1210 if it is suitable for use in additional processes. If the dried quinoa is determined 1210 to be unsuitable, the quinoa is disposed 1212.

If the quinoa is suitable, it is soaked 1214 in a soaker 308. The quinoa may be soaked 1214 for a predetermined length of time. It may, for example, be soaked 1214 for approximately twenty four hours.

In certain embodiments, the quinoa is freeze dried 1216 in a freeze dryer 310. The quinoa may be micronized 1218 in a micronizer 312 that outputs quinoa particles of a predetermined particle size. In one embodiment, the quinoa is extruded 1220 in an extruder 318.

The extruded quinoa may be baked 1222 in a cooker 314. The cooker 314 may be controlled by a temperature controller 316. The cooker 314 may bake 1222 the quinoa in more than one zone having a different temperature in each zone controlled by the temperature controller 316. The cooker 314 may be integrated with the extruder 318.

In some embodiments, the system 100 determines 1224 if the baked quinoa is to be flavored. If the baked quinoa is not to be flavored, it is packaged 1226 in a packager 324 and output 1228 as unflavored snack.

If the baked quinoa is to be flavored, flavoring is added 1230 in a coater 322. The flavored quinoa is packaged 1232 in the packager 324 and is output 1234 as flavored snack.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for producing powdered quinoa comprising:
dehulling quinoa in a dehuller;
drying the quinoa in a dryer;
soaking the quinoa in a soaker;
extruding the quinoa in an extruder; and
grinding the quinoa in a grinder.

2. The method of claim 1, wherein dehulling comprises wet dehulling and dry dehulling;

3. The method of claim 1, wherein soaking comprises soaking the quinoa for over eight hours.

4. The method of claim 1, wherein soaking comprises soaking the quinoa for between twenty two and twenty six hours.

5. The method of claim 1, wherein soaking comprises soaking the quinoa for a period of time sufficient to initiate germination of the quinoa.

6. The method of claim 1, further comprising cooking the quinoa in the extruder.

7. The method of claim 6, wherein cooking comprises three stages wherein the first stage is within 5° C. of 80° C. and the third stage is within 5° C. of 140° C.

8. The method of claim 7, wherein the second stage is within 5° C. of 100° C.

9. The method of claim 1, wherein the extruder comprises a twin-screw extruder.

10. The method of claim 9, wherein the extruder has a rotation speed between 1000 RPM and 1800 RPM.

11. The method of claim 9, wherein the extruder has a rotation speed between 1300 RPM and 1500 RPM.

12. The method of claim 9, wherein the extruder comprises a die comprising two 4 mm apertures.

13. The method of claim 1, further comprising micronizing extruded quinoa such that between 11% and 13% is retained on sieve #200 and that between 9% and 11% is retained on sieve #325.

14. A system for a quinoa processor, the system comprising:
a dehuller configured to remove hull from quinoa;
a dryer configured to dry quinoa;
a soaker configured to soak quinoa;
an extruder configured to extrude quinoa;
a grinder configured to grind quinoa; and
a micronizer configured to output particles below a predetermined size.

15. The system of claim 14, wherein the dehuller comprises a dry dehuller and a wet dehuller.

16. The system of claim 14, wherein the extruder comprises two screws.

17. The system of claim 16, wherein the extruder comprises a multi-zone temperature controller.

18. The system of claim 14, further comprising a packager configured to package quinoa powder produced by the system.
